(19) United States
(12) Patent Application Publication
(10) Pub. No.: US 2011/0055459 A1
(43) Pub. Date: Mar. 3, 2011

(54) METHOD FOR MANAGING A PLURALITY OF BLOCKS OF A FLASH MEMORY, AND ASSOCIATED MEMORY DEVICE AND CONTROLLER THEREOF

(76) Inventors: Bo CHEN, San Jose, CA (US); Shuihua HU, Shanghai (CN); Wei-Qing LI, Shanghai (CN); Xiangrong LI, Beijing (CN)

(21) Appl. No.: 12/764,964

(22) Filed: Apr. 22, 2010

(30) Foreign Application Priority Data
Sep. 2, 2009 (TW) 098129598

(51) Int. Cl. G06F 12/00; G06F 12/02; G06F 12/10

(52) U.S. Cl. 711/103; 711/206; 711/E12.001; 711/E12.008; 711/E12.059

(57) ABSTRACT

A method for managing a plurality of blocks of a Flash memory includes: dynamically determining a link type regarding a logical block address according to at least one criterion, where the link type is selected from a plurality of predetermined link types; and regarding the logical block address, recording/updating the link type and linking information corresponding to the link type. An associated memory device and a controller thereof are also provided, where the controller includes: a ROM arranged to store a program code; and a microprocessor arranged to execute the program code to control the access to the Flash memory and manage the plurality of blocks.

### BACKGROUND OF THE INVENTION

1. Field of the Invention

The present invention relates to access to a Flash memory, and more particularly, to a method for managing a plurality of blocks of a Flash memory, and to an associated memory device and a controller thereof.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. Although there are some solutions proposed by the related art in response to these problems, it seems unlikely that the related art gives consideration to both operation performance and system resource management. As a result, no matter which solution is chosen, a corresponding side effect typically exists. Therefore, a novel method is required for enhancing the control of data access of a Flash memory in a memory device, in order to give consideration to both operation performance and system resource management.

### SUMMARY OF THE INVENTION

It is therefore an objective of the claimed invention to provide a method for managing a plurality of blocks of a Flash memory, and to provide an associated memory device and a controller thereof, in order to solve the above-mentioned problems.

It is another objective of the claimed invention to provide a method for managing a plurality of blocks of a Flash memory, and to provide an associated memory device and a controller thereof, in order to reach the best operation performance and dynamically decrease the operation load.

It is another objective of the claimed invention to provide a method for managing a plurality of blocks of a Flash memory, and to provide an associated memory device and a controller thereof, in order to dynamically prevent problems of the pure page linking architecture and problems of the pure block linking architecture. Additionally, portable memory devices implemented according to the present invention usually have a longer lifetime.

According to a preferred embodiment of the claimed invention, a method for managing a plurality of blocks of a Flash memory comprises: dynamically determining a link type regarding a logical block address according to at least one criterion, wherein the link type is selected from a plurality of predetermined link types; and regarding the logical block address, recording/updating the link type and linking information corresponding to the link type.

While the method mentioned above is disclosed, an associated memory device is further provided. The memory device comprises: a Flash memory comprising a plurality of blocks; and a controller arranged to access the Flash memory and manage the plurality of blocks. In addition, the controller dynamically determines a link type regarding a logical block address according to at least one criterion, where the link type is selected from a plurality of predetermined link types. Additionally, regarding the logical block address, the controller records/updates the link type and linking information corresponding to the link type.

While the method mentioned above is disclosed, a controller of a memory device is further provided, where the controller is utilized for accessing a Flash memory comprising a plurality of blocks. The controller comprises: a read only memory (ROM) arranged to store a program code; and a microprocessor arranged to execute the program code to control the access to the Flash memory and manage the plurality of blocks. In addition, the controller that executes the program code by utilizing the microprocessor dynamically determines a link type regarding a logical block address according to at least one criterion, where the link type is selected from a plurality of predetermined link types. Additionally, regarding the logical block address, the controller that executes the program code by utilizing the microprocessor records/updates the link type and linking information corresponding to the link type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device according to a first embodiment of the present invention.

FIG. 2 is a flowchart of a method for managing a plurality of blocks of a Flash memory according to an embodiment of the present invention.

FIGS. 3-6 illustrate diagrams of some predetermined link types involved with the method shown in FIG. 2 according to an embodiment of the present invention.

FIG. 7 illustrates a diagram of some predetermined link types involved with the method shown in FIG. 2 and linking information respectively corresponding to the predetermined link types according to an embodiment of the present invention.

FIG. 8 illustrates a diagram of some predetermined link types involved with the method shown in FIG. 2 and linking information respectively corresponding to the predetermined link types according to another embodiment of the present invention.

### DETAILED DESCRIPTION

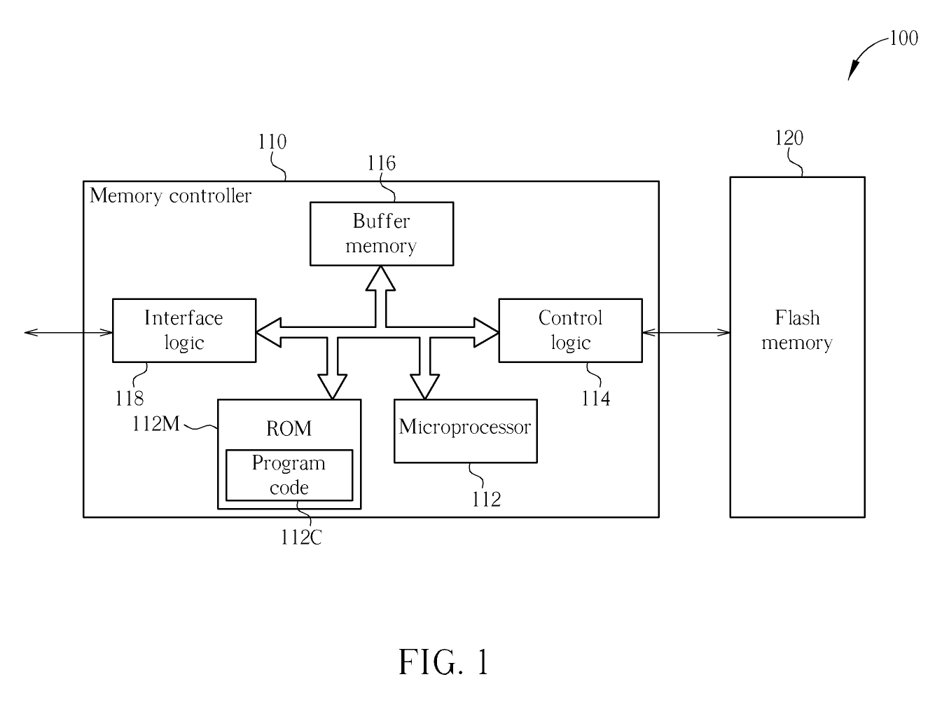

Please refer to FIG. 1, which illustrates a diagram of a memory device 100 according to a first embodiment of the present invention. In particular, the memory device 100 of this embodiment is a portable memory device, such as a memory card complying with SD/MMC, CF, MS, or XD standards. The memory device 100 comprises a Flash memory 120, and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control the access to the Flash memory 120. Please note that, according to different variations of this embodiment, the program code 112C can be stored in the buffer memory 116 or any other memory.

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller mentioned above performs data writing operations on the Flash memory 120 by writing/programming in units of pages.

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device.

According to this embodiment, in addition to accessing the Flash memory 120, the controller is capable of properly managing the plurality of blocks. More specifically, when writing/updating data, the controller can dynamically determine a link type regarding a logical block address according to at least one criterion, where the link type is selected from a plurality of predetermined link types. In addition, regarding the logical block address, the controller can record/update the link type and linking information corresponding to the link type.

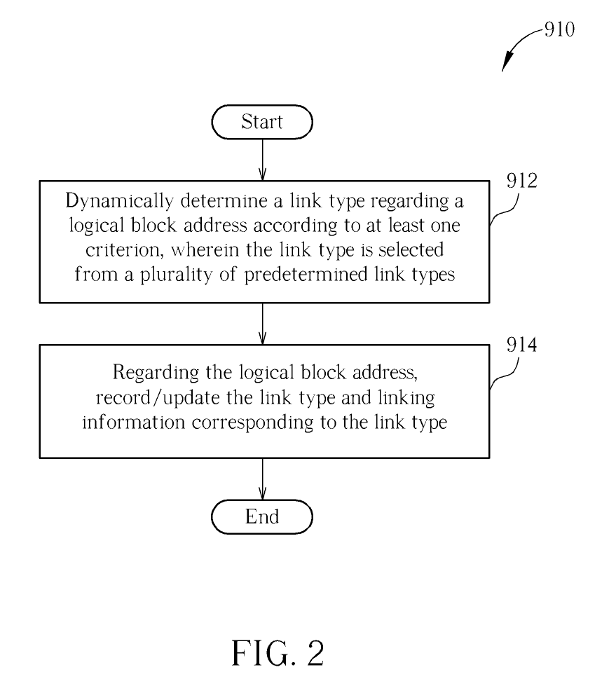

FIG. 2 is a flowchart of a method 910 for managing a plurality of blocks of a Flash memory according to an embodiment of the present invention. The method can be applied to the memory device 100 shown in FIG. 1, and more particularly, to the controller mentioned above (e.g. the memory controller 110 that executes the program code 112C by utilizing the microprocessor 112). In addition, the method can be implemented by utilizing the memory device 100 shown in FIG. 1, and more particularly, by utilizing the controller mentioned above. The method 910 is described as follows.

In Step 912, the aforementioned controller (e.g. the memory controller 110 that executes the program code 112C by utilizing the microprocessor 112) dynamically determines a link type regarding a logical block address according to at least one criterion, where the link type is selected from a plurality of predetermined link types. For example, the plurality of predetermined link types comprises a first link type, a second link type, and a third link type. More particularly, when the criterion indicates that links between logical pages and physical pages are necessary, under control of the controller, the link type is involved with the links between logical pages and physical pages (which can be simply referred to as the page links); otherwise, the link type can be merely involved with links between logical blocks and physical blocks (which can be simply referred to as the block links). According to this embodiment, under control of the controller, the link type can be dynamically switched between one or more types belonging to the page linking scheme and one or more types belonging to the block linking scheme.

In Step 914, regarding the logical block address, the controller records/updates the link type and linking information corresponding to the link type. For example, when the link type is the first link type, the linking information comprises a physical block address. In another example, when the link type is the second link type, the linking information comprises a physical block address and current physical page location information, and the current physical page location information is utilized for indicating the location of the latest written physical page regarding the logical block address. In another example, when the link type is the third link type, the linking information comprises page linking information.

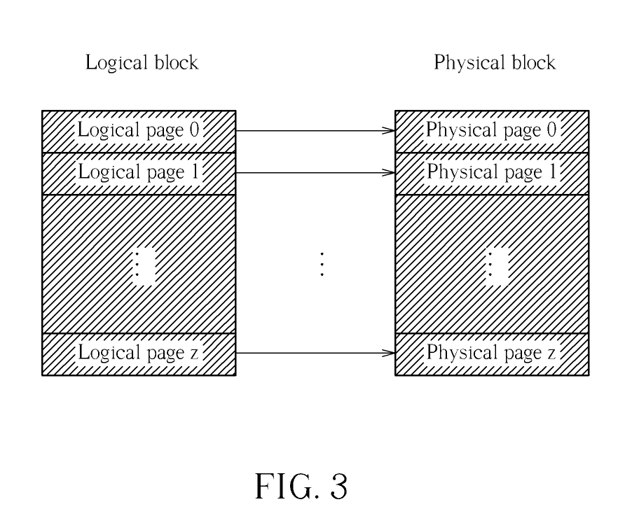

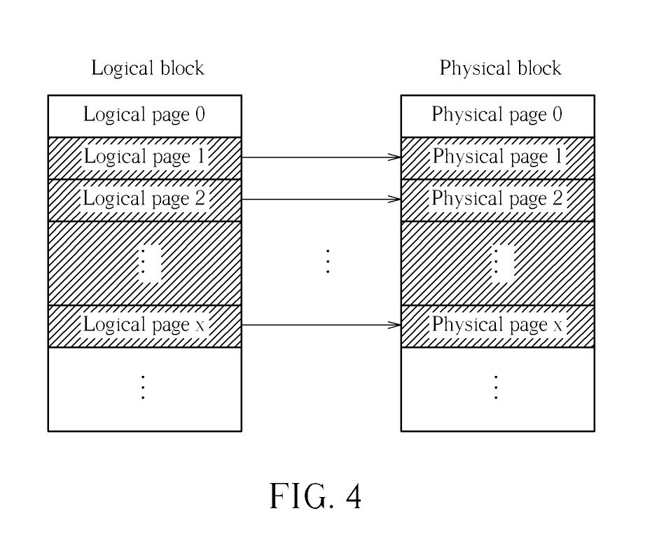

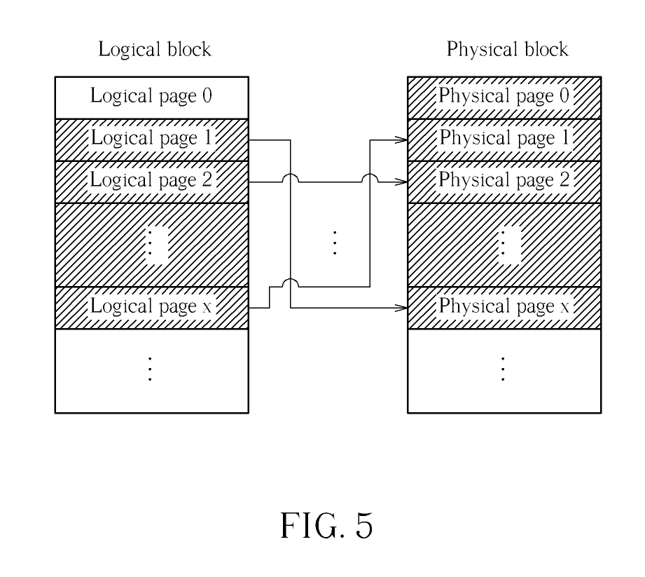

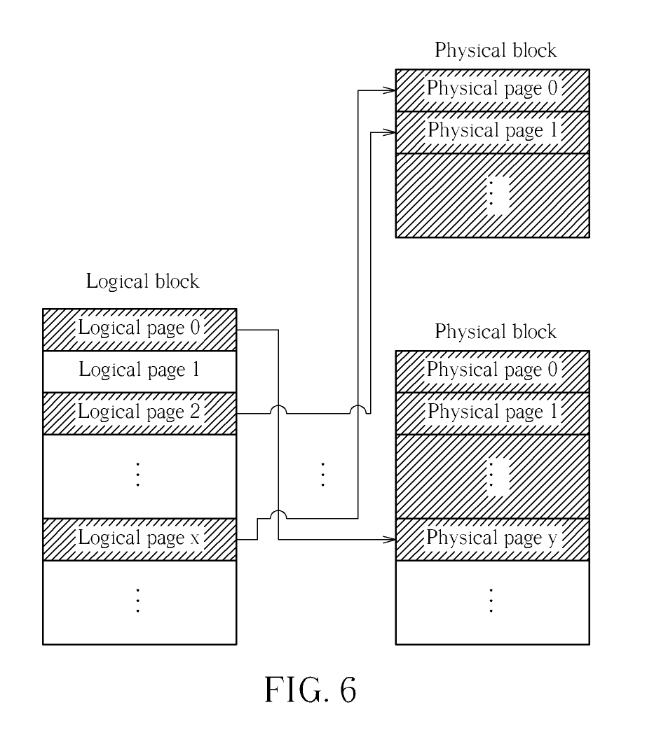

FIGS. 3-6 illustrate diagrams of some predetermined link types involved with the method 910 shown in FIG. 2 according to an embodiment of the present invention, where FIGS. 3-4 respectively correspond to the first and the second link types mentioned above, and FIGS. 5-6 correspond to the third link type mentioned above. As shown in FIG. 3, when the controller determines in Step 912 that the link type is the first link type, under control of the controller, the logical block represented by the logical block address links to a physical block, and all logical pages 0, 1, . . . , and z for controlling the logical block respectively link to physical pages 0, 1, . . . , and z of the physical block. Here, the first link type can be referred to as the “Direct Link”.

In addition, as shown in FIG. 4, when the controller determines in Step 912 that the link type is the second link type, under control of the controller, the logical block represented by the logical block address links to a physical block. However, only a portion of logical pages of the logical block, such as logical pages 1, 2, . . . , and x, respectively link to a portion of physical pages of the physical block, such as physical pages 1, 2, . . . , and x of the physical block. Here, the second link type can be referred to as the “Partial Direct Link”.

Additionally, when the controller determines in Step 912 that the link type is the third link type, under control of the controller, the logical block represented by the logical block address selectively links to one or more physical blocks, and the logical pages of the logical block randomly link to the physical pages of the physical block(s). Here, the third link type can be referred to as the “Random Link”. For example, the logical block shown in FIG. 5 links to a physical block, and logical pages 1, 2, . . . , and x of the logical block randomly link to physical pages 1, 2, . . . , and x of the physical block, as illustrated with the arrowheads shown in FIG. 5. In another example, the logical block shown in FIG. 6 links to two physical blocks, and logical pages 0, 1, . . . , and x of the logical block randomly link to physical pages 0, 1, . . . , etc. of the physical block shown in the upper-right of FIG. 6 and physical pages 0, 1, . . . , and y of the physical block shown in the bottom-right of FIG. 6, as illustrated with the arrowheads shown in FIG. 6. In another embodiment, the logical pages belonging to different logical block addresses (e.g. the logical page 3 belonging to the logical block address LB(p) and the logical page 7 belonging to the logical block address LB(q)) can randomly link to different logical pages belonging to the same physical block address (e.g. the logical pages 8 and 9 belonging to the physical block address PBA(Y_0)).

Please note that, in this embodiment, FIGS. 5-6 correspond to the third link type mentioned above. This is for illustrative purposes only, and is not meant to be a limitation of the present invention. According to a variation of this embodiment, the third link type can be divided into at least two link types, which respectively correspond to the numbers of physical blocks linked by the logical block.

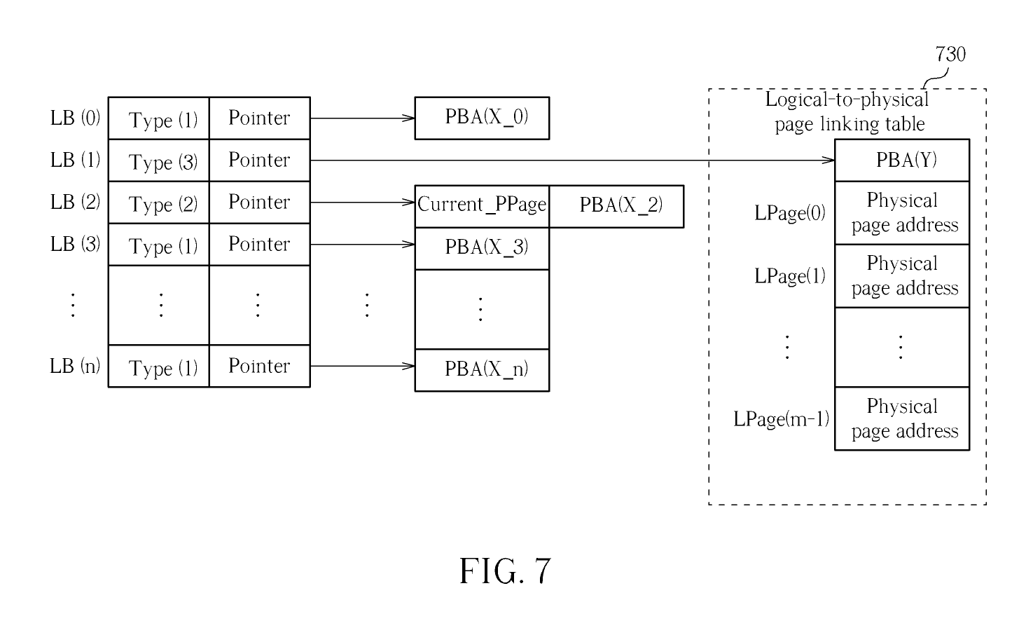

FIG. 7 illustrates a diagram of some predetermined link types involved with the method 910 shown in FIG. 2 and the linking information respectively corresponding to the predetermined link types according to an embodiment of the present invention, where the predetermined link types Type(1), Type(2), and Type(3) respectively represent the first, the second, and the third link types mentioned above. In this embodiment, the linking information corresponding to the predetermined link type Type(1) comprises a physical block address and a pointer pointing to the physical block address. For example, regarding the logical block address LB(0), the link type is the predetermined link type Type(1), where the linking information corresponding to the predetermined link type Type(1) comprises the physical block address PBA(X_0) and the pointer pointing to the physical block address PBA(X_0). Similarly, regarding the logical block address LB(i), when i=3, 4, . . . , or n, the link type is the predetermined link type Type(1), where the linking information corresponding to the predetermined link type Type(1) comprises the physical block address PBA(X_i) and the pointer pointing to the physical block address PBA(X_i).

In addition, the linking information corresponding to the predetermined link type Type(2) comprises the current physical page location information and a physical block address, and further comprises a pointer pointing to the current physical page location information and/or the physical block address. For example, regarding the logical block address LB(2), the link type is the predetermined link type Type(2), where the linking information corresponding to the predetermined link type Type(2) comprises the current physical page location information Current_PPage and the physical block address PBA(X_2), and further comprises the pointer pointing to the current physical page location information Current_PPage and/or the physical block address PBA(X_2). More particularly, in this embodiment, the current physical page location information Current_PPage shown in FIG. 7 is arranged to be in front of the physical block address PBA(X_2), while the pointer regarding the logical block address LB(2) points to the current physical page location information Current_PPage. This is for illustrative purposes only, and is not meant to be a limitation of the present invention. According to a variation of this embodiment, the physical block address PBA(X_2) can be arranged to be in front of the current physical page location information Current_PPage, while the pointer regarding the logical block address LB(2) may point to the physical block address PBA(X_2).

Additionally, the linking information corresponding to the predetermined link type Type(3) comprises the page linking information and a pointer pointing to the page linking information. For example, regarding the logical block address LB(1), the link type is the predetermined link type Type(3), where the linking information corresponding to the predetermined link type Type(3) comprises a logical-to-physical page linking table 730 and the pointer pointing to the logical-to-physical page linking table 730. As shown in FIG. 7, the controller records/updates a physical block address PBA(Y) regarding the logical block address LB(1). More particularly, in the logical-to-physical page linking table 730, regarding a logical page address LPage(j) belonging to the logical block address LB(1), the controller records/updates a corresponding physical page address, so that the data belonging to the logical block address LB(1) can be found in the future, where j=0, 1, . . . , or (m−1). As a result, the logical-to-physical page linking table 730 comprises the physical block address PBA(Y) and m physical page addresses respectively corresponding to the logical page addresses LPage(0), LPage(1), . . . , and LPage(m−1) belonging to the logical block address LB(1). This is for illustrative purposes only, and is not meant to be a limitation of the present invention. According to a variation of this embodiment, the physical block address PBA(Y) can be positioned (or stored) outside the logical-to-physical page linking table 730. According to another variation of this embodiment, the logical-to-physical page linking table may comprise two or more physical block addresses.

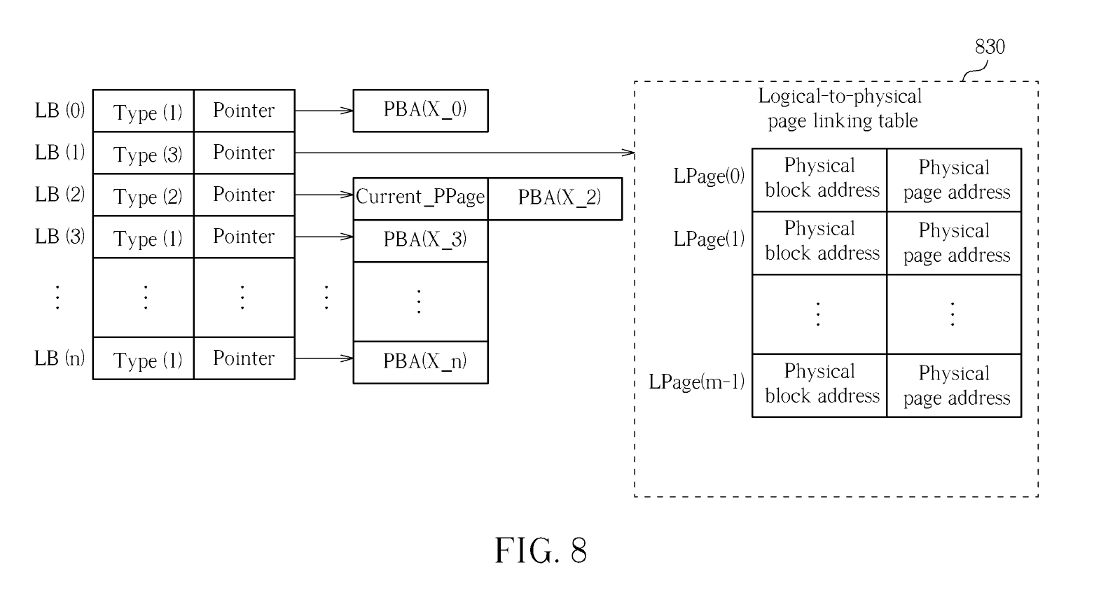

FIG. 8 illustrates a diagram of some predetermined link types involved with the method 910 shown in FIG. 2 and the linking information respectively corresponding to the predetermined link types according to another embodiment of the present invention. This embodiment is a variation of the embodiment shown in FIG. 7, where the logical-to-physical page linking table 730 mentioned above is replaced by another logical-to-physical page linking table 830. In the logical-to-physical page linking table 830, regarding a logical page address LPage(j) belonging to the logical block address LB(1), the controller records/updates a corresponding physical block address and a corresponding physical page address, where j=0, 1, . . . , or (m−1). More particularly, in the logical-to-physical page linking table 830, the controller records/updates a plurality of sets of physical block addresses and physical page addresses, so that the data belonging to the logical block address LB(1) can be found in the future, where any two of the physical block addresses can be different from each other (e.g. the physical block addresses in the logical-to-physical page linking table 830 may comprise the physical block addresses PBA(Y_1), PBA(Y_7), PBA(Y_3), etc.). As shown in FIG. 8, each row (or entry) of the logical-to-physical page linking table 830 comprises a set of physical block address and physical page address, and the respective rows (or entries), starting from the topmost row (or entry) through to the bottommost row (or entry), respectively correspond to the logical page addresses LPage(0), LPage(1), . . . , and LPage(m−1) belonging to the logical block address LB(1). Similar descriptions are not repeated in detail for this embodiment.

It is an advantage of the present invention that, regarding the selection of the link type, the present invention method and the associated memory device and the controller thereof can dynamically switch between modes of the types belonging to the page linking scheme and modes of the types belonging to the block linking scheme in response to the writing behaviors of the host device, so the present invention method and the associated memory device and the controller thereof can reach the best operation performance and dynamically decrease the operation load. For example, when the host device continuously and completely writes a certain logical block, the mode of “Direct Link” is suitable for use regarding the link type. In another example, when the host device continuously and partially writes a certain logical block, the mode of “Partial Direct Link” is suitable for use regarding the link type. In another example, the host device continuously writes a certain logical block in an initial period and then changes its own writing behaviors (e.g. the host device changes to randomly write), the mode of “Partial Direct Link” can be dynamically changed to the mode of “Random Link”, for use regarding the link type. In addition, in contrast to the related art, the present invention method and the associated memory device and the controller thereof can provide better performance and dynamically prevent problems of the pure page linking architecture and problems of the pure block linking architecture. Additionally, portable memory devices implemented according to the present invention usually have a longer lifetime.

Those skilled in the art will readily observe that numerous modifications and alterations of the device and method may be made while retaining the teachings of the invention.

What is claimed is:

1. A method for managing a plurality of blocks of a Flash memory, the method comprising:
dynamically determining a link type regarding a logical block address according to at least one criterion, wherein the link type is selected from a plurality of predetermined link types; and
regarding the logical block address, recording/updating the link type and linking information corresponding to the link type.

2. The method of claim 1, wherein the plurality of predetermined link types comprises a first link type; and when the link type is the first link type, the linking information comprises a physical block address.

3. The method of claim 1, wherein the plurality of predetermined link types comprises a second link type; and when the link type is the second link type, the linking information comprises a physical block address and current physical page location information, and the current physical page location information is utilized for indicating a location of a latest written physical page regarding the logical block address.

4. The method of claim 1, wherein the plurality of predetermined link types comprises a third link type; and when the link type is the third link type, the linking information comprises page linking information.

5. The method of claim 4, wherein the page linking information comprises a logical-to-physical page linking table; and the step of recording/updating the link type and the linking information corresponding to the link type further comprises:
recording/updating a physical block address regarding the logical block address; and
in the logical-to-physical page linking table, regarding a logical page address belonging to the logical block address, recording/updating a corresponding physical page address.

6. The method of claim 4, wherein the page linking information comprises a logical-to-physical page linking table; and the step of recording/updating the link type and the linking information corresponding to the link type further comprises:
in the logical-to-physical page linking table, regarding a logical page address belonging to the logical block address, recording/updating a corresponding physical block address and a corresponding physical page address.

7. The method of claim 1, further comprising:
regarding the logical block address, accessing data according to the link type and the linking information corresponding to the link type.

8. The method of claim 1, wherein when the criterion indicates that links between logical pages and physical pages are necessary, the link type is involved with links between logical pages and physical pages; otherwise, the link type is involved with links between logical blocks and physical blocks.

9. A memory device, comprising:
a Flash memory comprising a plurality of blocks; and
a controller arranged to access the Flash memory and manage the plurality of blocks, wherein the controller dynamically determines a link type regarding a logical block address according to at least one criterion, and the link type is selected from a plurality of predetermined link types;
wherein regarding the logical block address, the controller records/updates the link type and linking information corresponding to the link type.

10. The memory device of claim 9, wherein the plurality of predetermined link types comprises a first link type; and when the link type is the first link type, the linking information comprises a physical block address.

11. The memory device of claim 9, wherein the plurality of predetermined link types comprises a second link type; and when the link type is the second link type, the linking information comprises a physical block address and current physical page location information, and the current physical page location information is utilized for indicating a location of a latest written physical page regarding the logical block address.

12. The memory device of claim 9, wherein the plurality of predetermined link types comprises a third link type; and when the link type is the third link type, the linking information comprises page linking information.

13. The memory device of claim 12, wherein the page linking information comprises a logical-to-physical page linking table; the controller records/updates a physical block address regarding the logical block address; and in the logical-to-physical page linking table, regarding a logical page address belonging to the logical block address, the controller records/updates a corresponding physical page address.

14. The memory device of claim 12, wherein the page linking information comprises a logical-to-physical page linking table; and in the logical-to-physical page linking table, regarding a logical page address belonging to the logical block address, the controller records/updates a corresponding physical block address and a corresponding physical page address.

15. The memory device of claim 9, wherein regarding the logical block address, the controller accesses data according to the link type and the linking information corresponding to the link type.

16. The memory device of claim 9, wherein when the criterion indicates that links between logical pages and physical pages are necessary, under control of the controller, the link type is involved with links between logical pages and physical pages; otherwise, the link type is involved with links between logical blocks and physical blocks.

17. A controller of a memory device, the controller being utilized for accessing a Flash memory comprising a plurality of blocks, the controller comprising:
a read only memory (ROM) arranged to store a program code; and
a microprocessor arranged to execute the program code to control the access to the Flash memory and manage the plurality of blocks;
wherein the controller that executes the program code by utilizing the microprocessor dynamically determines a link type regarding a logical block address according to at least one criterion, and the link type is selected from a plurality of predetermined link types;
and regarding the logical block address, the controller that executes the program code by utilizing the microprocessor records/updates the link type and linking information corresponding to the link type.

18. The controller of claim 17, wherein the plurality of predetermined link types comprises a first link type; and when the link type is the first link type, the linking information comprises a physical block address.

19. The controller of claim 17, wherein the plurality of predetermined link types comprises a second link type; and when the link type is the second link type, the linking information comprises a physical block address and current physical page location information, and the current physical page location information is utilized for indicating a location of a latest written physical page regarding the logical block address.

20. The controller of claim 17, wherein the plurality of predetermined link types comprises a third link type; and when the link type is the third link type, the linking information comprises page linking information.

21. The controller of claim 20, wherein the page linking information comprises a logical-to-physical page linking table; the controller that executes the program code by utilizing the microprocessor records/updates a physical block address regarding the logical block address; and in the logical-to-physical page linking table, regarding a logical page address belonging to the logical block address, the controller that executes the program code by utilizing the microprocessor records/updates a corresponding physical page address.

22. The controller of claim 20, wherein the page linking information comprises a logical-to-physical page linking table; and in the logical-to-physical page linking table, regarding a logical page address belonging to the logical block address, the controller that executes the program code by utilizing the microprocessor records/updates a corresponding physical block address and a corresponding physical page address.

23. The controller of claim 17, wherein regarding the logical block address, the controller that executes the program code by utilizing the microprocessor accesses data according to the link type and the linking information corresponding to the link type.

24. The controller of claim 17, wherein when the criterion indicates that links between logical pages and physical pages are necessary, under control of the controller, the link type is involved with links between logical pages and physical pages; otherwise, the link type is involved with links between logical blocks and physical blocks.
